(19) United States
(12) Patent Application Publication
(10) Pub. No.: US 2021/0101171 A1
(43) Pub. Date: Apr. 8, 2021

(54) COATING BOOTH AND COATING METHOD

(71) Applicant: TOYOTA JIDOSHA KABUSHIKI KAISHA, Toyota-shi (JP)

(72) Inventors: Akira NUMASATO, Nagoya-shi (JP); Shinji TANI, Miyoshi-shi (JP); Kazuki TANAKA, Toyota-shi (JP); Takufumi KIMURA, Toyokawa-shi, (JP)

(73) Assignee: TOYOTA JIDOSHA KABUSHIKI KAISHA, Toyota-shi, (JP)

(21) Appl. No.: 16/915,210

(22) Filed: Jun. 29, 2020

(30) Foreign Application Priority Data
Oct. 4, 2019 (JP) 2019-183943

(51) Int. Cl. B05B 16/60; B05D 1/02; B05B 13/04

(52) U.S. Cl. CPC B05B 16/60; B05D 1/02; B05B 16/95; B05B 13/0421; B05B 13/0431

(57) ABSTRACT

A coating booth includes a coating chamber in which coating is performed on a coated object by a coating device, a supply air chamber placed above the coating chamber, and a recovery chamber placed below the coating chamber. The coating booth is configured such that: air directed from the supply air chamber toward the recovery chamber flows through a predetermined region inside the coating chamber, the predetermined region including a passage region for the coated object; and the air directed from the supply air chamber toward the recovery chamber does not flow through a predetermined-region outside region inside the coating chamber.

### INCORPORATION BY REFERENCE

The disclosure of Japanese Patent Application No. 2019-183943 filed on Oct. 4, 2019 including the specification, drawings and abstract is incorporated herein by reference in its entirety.

### BACKGROUND

### 1. Technical Field

The present disclosure relates to a coating booth and a coating method.

### 2. Description of Related Art

A coating booth including a coating chamber and a discharge air chamber has been known in the related art (for example, see Japanese Unexamined Patent Application Publication No. 2011-206718 (JP 2011-206718 A)). The coating chamber is provided with a coating device, and the discharge air chamber is placed below the coating chamber.

In the coating booth of JP 2011-206718 A, at the time when coating is performed on a coated object by the coating device, ventilation air is supplied to the whole chamber from a ceiling of the coating chamber such that the air passes through the coating chamber and is discharged to the discharge air chamber. When such a flow (downflow) of the air is formed, paint particles (overspray mist) unattached to the coated object are discharged from the coating chamber. This makes it possible to restrain a decrease in coating quality and to restrain a working environment from worsening.

### SUMMARY

However, in the coating booth as described above, a downflow is formed inside the whole coating chamber, so that an energy consuming amount is large. Thus, there is room for improvement in this point.

The present disclosure has been accomplished in order to solve the above problem, and an object of the present disclosure is to provide a coating booth and a coating method each of which can reduce an energy consuming amount.

A coating booth of the present disclosure includes a coating chamber, a supply air chamber, and a recovery chamber. The coating chamber is provided with a coating device configured to atomize paint and apply the paint to a coated object such that coating is performed on the coated object by the coating device. The supply air chamber is placed above the coating chamber, the supply air chamber being configured to supply air to the coating chamber. The recovery chamber is placed below the coating chamber, the recovery chamber being configured to recover paint particles in air discharged from the coating chamber. Air directed from the supply air chamber toward the recovery chamber flows through a predetermined region inside the coating chamber, the predetermined region including a passage region for the coated object. The air directed from the supply air chamber toward the recovery chamber does not flow through a predetermined-region outside region inside the coating chamber.

In such a configuration, at the time when coating is performed on the coated object by the coating device, the air directed from the supply air chamber toward the recovery chamber is introduced into the predetermined region inside the coating chamber, so that overspray mist can be discharged from the coating chamber. Further, at the time when coating is performed on the coated object by the coating device, the air is prevented from flowing through the predetermined-region outside region inside the coating chamber. This makes it possible to reduce an energy consuming amount in comparison with a case where the air is introduced into the whole coating chamber.

In the coating booth, an inlet opening via which the air is introduced from the supply air chamber to the coating chamber may be formed in a part of a ceiling of the coating chamber. The inlet opening may be placed so as to correspond to the passage region for the coated object.

With such a configuration, while the air is introduced into the predetermined region inside the coating chamber, the air can be prevented from flowing through the predetermined-region outside region inside the coating chamber.

In this case, the coating device may include a spray gun configured to atomize the paint, a robot arm configured to move the spray gun, and a support to which a base of the robot arm is attached. The support may be placed at a position that does not overlap the inlet opening in a plan view.

With such a configuration, it is possible to restrain the overspray mist from being attached to the support.

In the coating booth, a discharge opening via which the air is discharged from the coating chamber to the recovery chamber may be formed in a part of a floor of the coating chamber. The discharge opening may be placed so as to correspond to the passage region for the coated object.

With such a configuration, the air can be prevented from flowing through the predetermined-region outside region while the air is introduced into the predetermined region inside the coating chamber.

In the coating booth, the coating device may include a spray gun having a rotary head, and the coating device may be configured such that filamentous paint is emitted from the rotary head and the filamentous paint is electrostatically atomized.

In such a configuration, the paint can be atomized without using shaping air, and paint particles do not whirl up due to the shaping air. Accordingly, occurrence of overspray mist is restrained, so that a generation range of the overspray mist can be narrowed. This makes it possible to downsize the predetermined region where the air flows.

A coating method according to the present disclosure uses a coating booth including a coating chamber, a supply air chamber, and a recovery chamber. The coating chamber is provided with a coating device configured to atomize paint and apply the paint to a coated object such that coating is performed on the coated object by the coating device. The supply air chamber is placed above the coating chamber, the supply air chamber being configured to supply air to the coating chamber. The recovery chamber is placed below the coating chamber, the recovery chamber being configured to recover paint particles in air discharged from the coating chamber. The coating method includes: a step of introducing air directed from the supply air chamber toward the recovery chamber into a predetermined region inside the coating chamber, the predetermined region including a passage region for the coated object, and preventing the air directed from the supply air chamber toward the recovery chamber from flowing through a predetermined-region outside region inside the coating chamber; and a step of performing coating on the coated object by the coating device in a state where the air flows through the predetermined region while the air is prevented from flowing through the predetermined-region outside region.

In such a configuration, at the time when coating is performed on the coated object by the coating device, the air directed from the supply air chamber toward the recovery chamber is introduced into the predetermined region inside the coating chamber, so that overspray mist can be discharged from the coating chamber. Further, at the time when coating is performed on the coated object by the coating device, the air is prevented from flowing through the predetermined-region outside region inside the coating chamber. This makes it possible to reduce an energy consuming amount in comparison with a case where the air is introduced into the whole coating chamber.

With the coating booth and the coating method of the present disclosure, it is possible to reduce an energy consuming amount.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram to describe a coating booth according to the present embodiment;

FIG. 2 is a plan view illustrating an internal space of a coating chamber of the coating booth of FIG. 1;

FIG. 3 is a sectional view illustrating a spray gun of a coating device of the coating booth of FIG. 1;

FIG. 4 is a perspective view illustrating a distal end of a rotary head of the spray gun of FIG. 3;

FIG. 5 is a schematic view to describe electrostatic atomization by the coating device of FIG. 3; and

FIG. 6 is a schematic configuration diagram to describe a coating booth according to a modification of the present embodiment.

### DETAILED DESCRIPTION OF EMBODIMENTS

One embodiment of the present disclosure is described below.

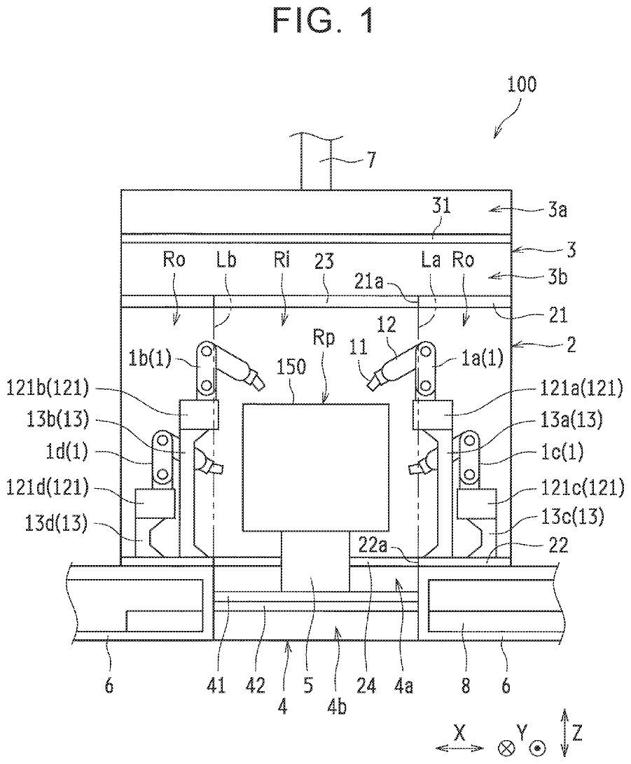

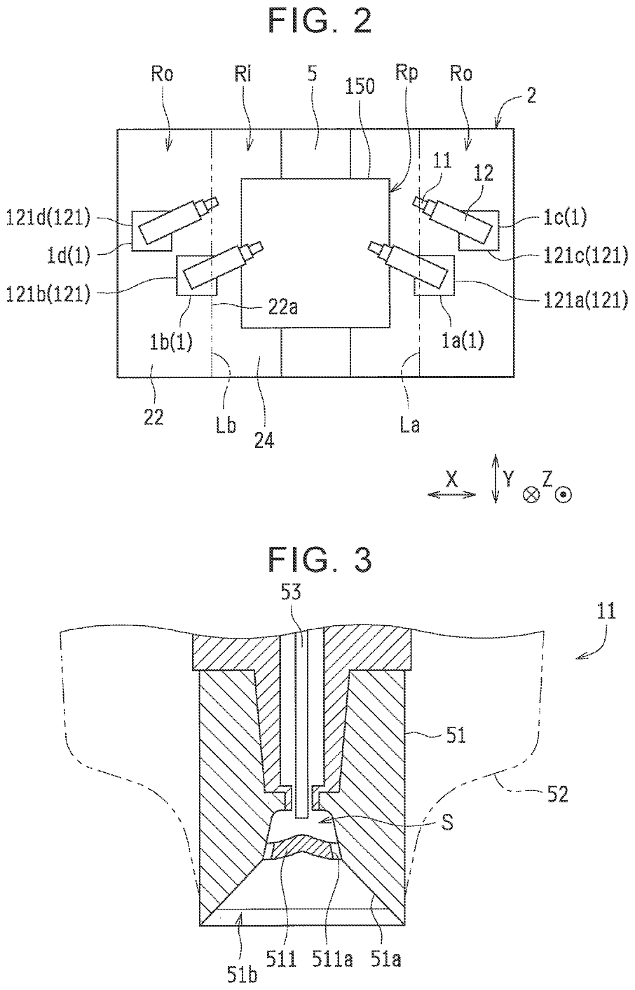

First described is a configuration of a coating booth 100 according to one embodiment of the present disclosure with reference to FIGS. 1 and 2.

The coating booth 100 is a facility in which coating to a coated object 150 is performed, and the coated object 150 is a body of a vehicle, for example. As illustrated in FIG. 1, the coating booth 100 includes a coating device 1, a coating chamber 2 in which the coating device 1 is provided, a supply air chamber 3 placed above the coating chamber 2, a recovery chamber 4 placed below the coating chamber 2, and a conveying device 5 configured to convey the coated object 150. Note that, in FIG. 1 and so on, an X-direction is the width direction of the coating booth 100, a Y-direction is the length direction of the coating booth 100 (a conveying direction of the coated object 150), and a Z-direction is the height direction (the up-down direction) of the coating booth 100.

The coating device 1 is configured to atomize paint and apply the paint to the coated object 150. The coating device 1 includes a spray gun 11 configured to atomize the paint, a robot arm 12 configured to move the spray gun 11, and a support 13 to which a base 121 of the robot arm 12 is attached. The support 13 is formed so as to extend upward from a floor 22 of the coating chamber 2. Note that details of the spray gun 11 will be described later.

In the present embodiment, four coating devices 1 are provided such that two sets of a pair of right and left coating devices 1 are provided. More specifically, a coating device 1a configured to perform coating on a top right part of the coated object 150, a coating device 1b configured to perform coating on a top left part of the coated object 150, a coating device 1c configured to perform coating on a lower right part of the coated object 150, and a coating device 1d configured to perform coating on a lower left part of the coated object 150 are provided.

That is, the coating devices 1a and 1b are placed to face each other in the width direction across a passage region Rp for the coated object 150, and the coating devices 1c and 1d are placed to face each other in the width direction across the passage region Rp for the coated object 150. On this account, a support 13a of the coating device 1a and a support 13b of the coating device 1b have the same length, and a support 13c of the coating device 1c and a support 13d of the coating device 1d have the same length. The supports 13a and 13b are formed to be longer than the supports 13c and 13d. Further, the support 13c is placed outward from the support 13a in the width direction, and the support 13d is placed outward from the support 13b in the width direction. Note that the coating devices 1c and 1d are placed on the downstream side (the upper side in FIG. 2) in the conveying direction relative to the coating devices 1a and lb.

The coating chamber 2 is provided so as to partition off a space in which the four coating devices 1 are accommodated and coating is performed by the four coating devices 1. The coating chamber 2 is supported by a support frame 6, and a space where the recovery chamber 4 is placed is secured below the coating chamber 2. An inlet opening 21a via which air is introduced is formed in a part of a ceiling 21 of the coating chamber 2, and a discharge opening 22a via which the air is discharged is formed in a part of the floor 22 of the coating chamber 2. The inlet opening 21a is provided with a filter 23, and the discharge opening 22a is provided with a grating plate 24. The filter 23 is provided so as to remove dust and so on in the air to be introduced into the coating chamber 2.

The supply air chamber 3 is provided so as to supply ventilation air into the coating chamber 2. A supply air duct 7 is connected to the supply air chamber 3, and air supplied from an air conditioner (not shown) with adjusted temperature and humidity flows into the supply air chamber 3 via the supply air duct 7. The supply air chamber 3 has a function to straighten the air flowing in through the supply air duct 7, and an air volume adjustment mechanism 31 is provided in an internal space of the supply air chamber 3. Hereby, the internal space of the supply air chamber 3 is partitioned into an upstream space 3a and a downstream space 3b by the air volume adjustment mechanism 31. The upstream space 3a communicates with the supply air duct 7, and the downstream space 3b communicates with the coating chamber 2 via the filter 23 of the inlet opening 21a. The air volume adjustment mechanism 31 is provided so as to adjust an air amount, per unit time, flowing from the upstream space 3a to the downstream space 3b. The air volume adjustment mechanism 31 is configured to adjust the volume of air in the supply air chamber 3 so that the volume of air around the coated object 150 becomes a value set in advance.

Further, the supply air chamber 3 is set to have the same size as the coating chamber 2 in a plan view. That is, the width (the length in the X-direction) of the supply air chamber 3 is the same as the width of the coating chamber 2, and the length (the length in the Y-direction) of the supply air chamber 3 is the same as the length of the coating chamber 2.

The recovery chamber 4 is provided so as to recover paint particles in the air discharged from the coating chamber 2. A discharge air duct 8 is connected to the recovery chamber 4, and the recovery chamber 4 communicates with outside via the discharge air duct 8. A filter 41 and an air volume adjustment mechanism 42 are provided in an internal space of the recovery chamber 4. On this account, the internal space of the recovery chamber 4 is partitioned into an upstream space 4a and a downstream space 4b by the filter 41 and the air volume adjustment mechanism 42. The filter 41 is placed above the air volume adjustment mechanism 42 such that the filter 41 faces the upstream space 4a, and the air volume adjustment mechanism 42 faces the downstream space 4b. The upstream space 4a communicates with the coating chamber 2 via the grating plate 24 of the discharge opening 22a, and the downstream space 4b communicates with the discharge air duct 8. The filter 41 is a thin dry filter and is provided so as to remove paint particles in the air. The air volume adjustment mechanism 42 is provided so as to adjust an air amount, per unit time, flowing from the upstream space 4a to the downstream space 4b. The air volume adjustment mechanism 42 is configured to adjust the volume of air in the recovery chamber 4 so that the volume of air around the coated object 150 becomes a value set in advance.

The conveying device 5 is provided so as to convey the coated object 150 into the coating chamber 2 and convey the coated object 150 out of the coating chamber 2. The conveying device 5 is configured to convey the coated object 150 to the deep side to the plane of paper of FIG. 1, for example. The conveying device 5 is placed in the discharge opening 22a of the coating chamber 2 and is provided so as to partition the upstream space 4a of the recovery chamber 4 into the right side and the left side.

Here, the coating booth 100 of the present embodiment is configured such that the air directed from the supply air chamber 3 toward the recovery chamber 4 flows into a predetermined region Ri inside the coating chamber 2, and the air directed from the supply air chamber 3 toward the recovery chamber 4 does not flow into predetermined-region outside regions Ro inside the coating chamber 2. The predetermined region Ri is a region including a passage region Rp through which the coated object 150 passes inside the coating chamber 2 and a region around the passage region Rp (a range where paint particles unattached to the coated object 150 at the time of coating float). The predetermined-region outside region Ro is a region other than the predetermined region Ri inside the coating chamber 2 and is placed outward from the predetermined region Ri in the width direction (the X-direction). That is, the predetermined-region outside regions Ro are placed in both end portions of the coating chamber 2 in the width direction, and the predetermined region Ri is placed between the predetermined-region outside regions Ro thus provided as one pair.

More specifically, the inlet opening 21a of the coating chamber 2 is placed to correspond to the passage region Rp for the coated object 150. The width (the length in the X-direction) of the inlet opening 21a is larger than the width of the coated object 150 but smaller than the width of the coating chamber 2. For example, the width of the inlet opening 21a is set based on the width of the coated object 150, a range where paint particles (overspray mist) unattached to the coated object 150 at the time of coating float, and so on. That is, the width of the inlet opening 21a is set such that, while the predetermined-region outside regions Ro through which no air flows are formed, the predetermined region Ri through which the air flows includes an overspray mist generation range. Note that the inlet opening 21a is provided over the whole length of the coating chamber 2 in the longitudinal direction (the Y-direction).

Further, the discharge opening 22a of the coating chamber 2 is placed so as to correspond to the passage region Rp for the coated object 150. The width (the length in the X-direction) of the discharge opening 22a is the same as the width of the inlet opening 21a, for example. Further, the width of the discharge opening 22a is set such that, while the predetermined-region outside regions Ro through which no air flows are formed, the predetermined region Ri through which the air flows includes the overspray mist generation range. Note that the discharge opening 22a is provided over the whole length of the coating chamber 2 in the longitudinal direction.

At this time, the air directed from the inlet opening 21a to the discharge opening 22a mainly passes through a space between an alternate long and two short dashes line La and an alternate long and two short dashes line Lb, the alternate long and two short dashes line La connecting a first end portion of the inlet opening 21a in the width direction to a first end portion of the discharge opening 22a in the width direction, the alternate long and two short dashes line Lb connecting a second end portion of the inlet opening 21a in the width direction to a second end portion of the discharge opening 22a in the width direction. On this account, the predetermined region Ri is a region including the space between the alternate long and two short dashes lines La and Lb, and a space corresponding to expansion of air stream in addition to the space, for example.

The support 13 of each coating device 1 is placed outward from the inlet opening 21a and the discharge opening 22a in the width direction. That is, the supports 13a to 13d are placed at positions that do not overlap the inlet opening 21a and the discharge opening 22a (positions deviating from the inlet opening 21a and the discharge opening 22a ) in a plan view. Accordingly, the supports 13a to 13d are placed in the predetermined-region outside regions Ro.

Further, a base 121c of the coating device 1c and a base 121d of the coating device 1d are placed outward from the inlet opening 21a and the discharge opening 22a in the width direction. That is, the base 121c and the base 121d are placed at positions that do not overlap the inlet opening 21a and the discharge opening 22a in a plan view. Accordingly, the bases 121c and 121d are placed in the predetermined-region outside regions Ro.

Further, a most part of the base 121a of the coating device 1a is placed at a position that does not overlap the inlet opening 21a and the discharge opening 22a in a plan view, and an inner end portion of the base 121a is placed at a position that overlaps the inlet opening 21a and the discharge opening 22a in a plan view. Because of this, the most part of the base 121a is placed in the predetermined-region outside region Ro, and the inner end portion of the base 121a is placed in the predetermined region Ri. Note that, in terms of a part of the base 121a that overlaps the inlet opening 21a and the discharge opening 22a, a part of the base 121a that is placed in the predetermined region Ri increases just by expansion of the air stream.

Similarly, a most part of the base 121b of the coating device 1b is placed at a position that does not overlap the inlet opening 21a and the discharge opening 22a in a plan view, and an inner end portion of the base 121b is placed at a position that overlaps the inlet opening 21a and the discharge opening 22a in a plan view. Because of this, the most part of the base 121b is placed in the predetermined-region outside region Ro, and the inner end portion of the base 121b is placed in the predetermined region Ri. Note that, in terms of a part of the base 121b that overlaps the inlet opening 21a and the discharge opening 22a, a part of the base 121b that is placed in the predetermined region Ri increases just by expansion of the air stream.

Spray Gun

Next will be described the spray gun 11 of the coating device 1 with reference to FIGS. 3 to 5.

The spray gun 11 is configured to emit filamentous paint P1 from a rotary head 51 and electrostatically atomize the filamentous paint P1 so as to form paint particles (atomized paint) P2 and apply the paint particles P2 to the coated object 150.

As illustrated in FIG. 3, the spray gun 11 includes the rotary head 51, an air motor (not shown) configured to rotate the rotary head 51, a cap 52 configured to cover an outer peripheral surface of the rotary head 51, a paint supply pipe 53 configured to supply the paint to the rotary head 51, and a voltage generator 54 (see FIG. 5) configured to apply a negative high voltage to the rotary head 51.

The rotary head 51 is configured to receive supply of liquid paint and emit the paint by centrifugal force. A hub 511 is attached to the rotary head 51 so that a paint space S is formed, and hereby, the paint is supplied to the paint space S from the paint supply pipe 53. A plurality of outflow holes 511a through which the paint flows out from the paint space S is formed in an outer edge of the hub 511.

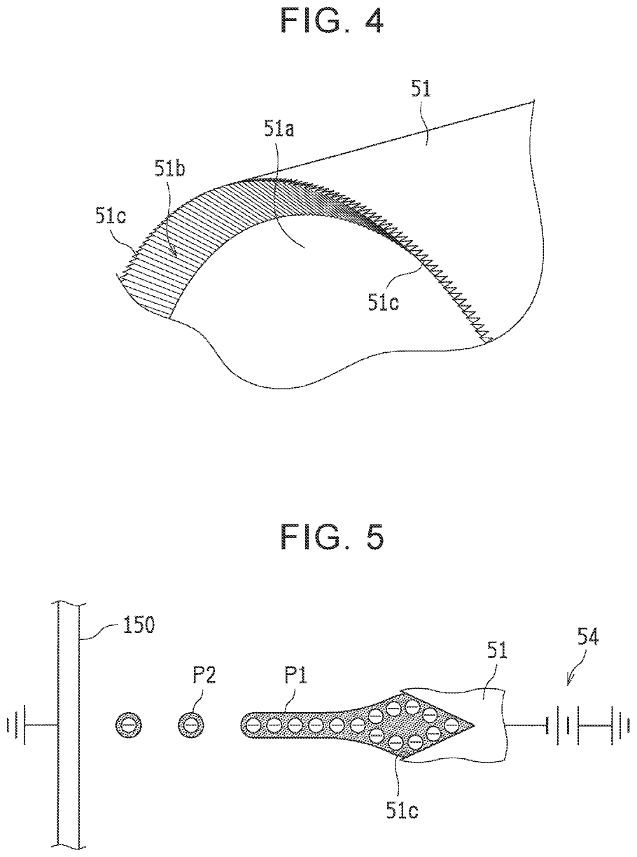

A diffusing surface 51a along which the paint is diffused by the centrifugal force is formed radially outward from the outflow holes 511a of the rotary head 51. The diffusing surface 51a is formed to increase in diameter toward a distal end side of the rotary head 51 so that the paint thus flowing out from the outflow holes 511a is formed into a film shape. Further, as illustrated in FIG. 4, grooves 51c are formed in an outer edge portion 51b of the diffusing surface 51a such that the filmy paint is emitted in a filamentous manner from the grooves 51c. Note that the grooves 51c are not illustrated in FIG. 3 in consideration of visibility.

The grooves 51c are formed along the circumferential direction so as to extend in the radial direction when the grooves 51c are viewed from the axial direction. That is, the grooves 51c are formed on the outer edge portion 51b of the diffusing surface 51a so as to extend in an inclination direction of the diffusing surface 51a. The grooves 51c are formed to reach a radially outer end portion of the rotary head 51. On this account, the distal end of the rotary head 51 has an uneven shape when the rotary head 51 is viewed from an outer peripheral surface side.

As illustrated in FIG. 5, in the spray gun 11, a negative high voltage is applied to the rotary head 51 by the voltage generator 54 so that the filamentous paint P1 emitted from the grooves 51c of the rotary head 51 is electrically charged, and the filamentous paint P1 is hereby split into the paint particles P2 by use of repulsive force caused by electrified charges. That is, the filamentous paint P1 emitted from the grooves 51c of the rotary head 51 is electrostatically atomized and turned into the paint particles P2. That is, since the coating device 1 is not provided with an air-discharge portion configured to discharge shaping air, the paint particles P2 are formed without depending on the shaping air. Accordingly, the coating device 1 employs a shaping-airless electrostatic atomization method, so that the paint particles do not whirl up due to the shaping air. Accordingly, the occurrence of overspray mist is restrained, and a generation range of the overspray mist is narrowed.

Operation of Coating

Next will be described an operation (a coating method by use of the coating booth 100) at the time of coating in the coating booth 100 according to the present embodiment with reference to FIGS. 1 to 5. Note that the coating in the coating booth 100 is performed in an unmanned state in the coating chamber 2, for example.

First, as illustrated in FIG. 1, before coating by the coating device 1 is started, the air with adjusted temperature and humidity flows from the air conditioner (not shown) into the supply air chamber 3 via the supply air duct 7. In the supply air chamber 3, the volume of the air is adjusted by the air volume adjustment mechanism 31, and the air thus adjusted is introduced into the coating chamber 2 via the filter 23 of the inlet opening 21a.

In the coating chamber 2, the air directed from the supply air chamber 3 toward the recovery chamber 4 flows into the predetermined region Ri. That is, the flow (downflow) of the air directed downward from the inlet opening 21a to the discharge opening 22a is formed in the predetermined region Ri. At this time, the air directed from the supply air chamber 3 toward the recovery chamber 4 does not flow through the predetermined-region outside regions Ro inside the coating chamber 2, and therefore, no downflow is formed.

Then, the air passing through the predetermined region Ri in the coating chamber 2 is discharged to the recovery chamber 4 via the grating plate 24 of the discharge opening 22a. In the recovery chamber 4, the volume of the air is adjusted by the air volume adjustment mechanism 42, and the air thus adjusted is released to outside via the discharge air duct 8.

Subsequently, in a state where the air is introduced into the predetermined region Ri while the air is prevented from flowing through the predetermined-region outside regions Ro, coating is performed on the coated object 150 by the coating device 1. The coating by the coating device 1 is performed while the coated object 150 is conveyed by the conveying device 5 (see FIG. 2), for example.

Each coating device 1 performs coating by the shaping-airless electrostatic atomization method. More specifically, as illustrated in FIG. 5, while a negative high voltage is applied to the rotary head 51 by the voltage generator 54, the rotary head 51 is rotated by an air motor (not shown) in a state where the coated object 150 is grounded. Note that a distance between the rotary head 51 and the coated object 150 is adjusted by the robot arm 12. Further, as illustrated in FIG. 3, liquid paint is supplied to the paint space S from the paint supply pipe 53, and the paint flows out from the outflow holes 511a by the centrifugal force.

The paint thus flowing out from the outflow holes 511a flows outward in the radial direction along the diffusing surface 51a by the centrifugal force. The paint flowing along the diffusing surface 51a becomes filmy and reaches the outer edge portion 51b, so that the paint is supplied to the grooves 51c (see FIG. 4). The paint does not overflow from the grooves 51c in the outer edge portion 51b, so that the paint in each groove 51c is separated from the paint in its adjacent groove 51c. That is, the filmy paint is divided by the grooves 51c in the circumferential direction. The paint passing through the grooves 51c becomes filamentous and is emitted from the radially outer end portion of the rotary head 51 (the grooves 51c appearing on the outer peripheral surface of the rotary head 51). Note that the film thickness of the filmy paint is uniform due to the centrifugal force, and the paint is supplied to each groove 51c generally equally, so that the filamentous paint P1 emitted from each groove 51c has a generally uniform dimension (length and diameter).

As illustrated in FIG. 5, the filamentous paint P1 emitted from the rotary head 51 is electrostatically atomized, so that the paint particles P2 are formed. An electric field is formed between the rotary head 51 and the coated object 150, and the paint particles P2 charged negatively are attracted to the coated object 150. On this account, the paint particles P2 are applied to the coated object 150, so that a coating film (not shown) is formed on the surface of the coated object 150.

Further, as illustrated in FIG. 1, in each coating device 1, while the coating is performed by the spray gun 11, the spray gun 11 is moved along the surface of the coated object 150 by the robot arm 12. On this account, the coating is performed on respective regions of the surface of the coated object 150 by respective coating devices 1. For example, the coating device 1a performs coating on a surface of the top right part of the coated object 150, the coating device 1b performs coating on a surface of the top left part of the coated object 150, the coating device 1c performs coating on a surface of the lower right part of the coated object 150, and the coating device 1d performs coating on a surface of the lower left part of the coated object 150. Hereby, the whole surface of the coated object 150 is coated with the paint.

Here, at the time of coating by the coating device 1, paint particles (overspray mist) unattached to the coated object 150 are caused. A generation range of the overspray mist is included in the predetermined region Ri. Accordingly, the overspray mist generated at the time of coating is carried downward by the downflow and is discharged to the recovery chamber 4. In the recovery chamber 4, the overspray mist is recovered by the filter 41. That is, the paint particles unattached to the coated object 150 are removed from the air by the filter 41, so that the air sent to the discharge air duct 8 is cleaned.

Effects

In the present embodiment, as described above, at the time when coating is performed on the coated object 150 by the coating device 1, the air directed from the supply air chamber 3 toward the recovery chamber 4 is introduced into the predetermined region Ri, so that the overspray mist can be discharged from the coating chamber 2. Hereby, it is possible to restrain a decrease in coating quality and to restrain a working environment from worsening. Further, at the time when coating is performed on the coated object 150 by the coating device 1, the air is prevented from flowing through the predetermined-region outside regions Ro. Hereby, in comparison with a case where the air flows through the whole coating chamber, it is possible to reduce an energy consuming amount. That is, at the time of coating by the coating device 1, a downflow is caused only in an area that requires the downflow. Hereby, the amount of air passing through the coating chamber 2 is reduced, thereby achieving a reduction in power consumption.

Further, in the present embodiment, the inlet opening 21a is formed in a part of the ceiling 21, and the discharge opening 22a is formed in a part of the floor 22 such that the inlet opening 21a and the discharge opening 22a are placed so as to correspond to the passage region Rp for the coated object 150. Hereby, while a downflow is formed in the predetermined region Ri, a downflow can be prevented from being formed in the predetermined-region outside regions Ro.

Further, in the present embodiment, the coating device 1 employs the shaping-airless electrostatic atomization method, so that the paint particles do not whirl up due to shaping air. Accordingly, the occurrence of overspray mist is restrained, so that the volume of air in the downflow is reduced and the generation range of the overspray mist is narrowed. This makes it possible to downsize the predetermined region Ri. This accordingly makes it possible to further reduce an energy consuming amount.

Further, in the present embodiment, the support 13 is placed in the predetermined-region outside region Ro, thereby making it possible to restrain the overspray mist from being attached to the support 13. Further, the bases 121c and 121d are placed in the predetermined-region outside regions Ro, and most parts of the bases 121a and 121b are placed in the predetermined-region outside regions Ro. This makes it possible to restrain the overspray mist from being attached to the bases 121a to 121d.

Further, in the present embodiment, the overspray mist is recovered by the filter 41 as a thin dry filter. This makes it possible to decrease the height of the recovery chamber 4, thereby making it possible to achieve downsizing of the coating booth 100.

Other Embodiments

Note that the embodiment described herein is just an example in all respects and does not serve as a base for limitative interpretation. Accordingly, the technical scope of the present disclosure is not interpreted only by the above embodiment but is defined based on the description in Claims. Further, the technical scope of the present disclosure includes all modifications made within the meaning and scope equivalent to Claims.

For example, the above embodiment deals with an example in which the coated object 150 is a body of a vehicle. However, the present disclosure is not limited to this, and the coated object may be a bumper of a vehicle, or the like.

Further, the above embodiment deals with an example in which the coating chamber 2 is provided with four coating devices 1. However, the present disclosure is not limited to this. The number of coating devices provided in the coating chamber may be any number.

Further, the above embodiment deals with an example in which the inlet opening 21a and the discharge opening 22a are placed so as to correspond to the passage region Rp for the coated object 150. However, the present disclosure is not limited to this, and the inlet opening and the discharge opening may not be placed so as to correspond to the passage region for the coated object.

Further, the above embodiment deals with an example in which the inlet opening 21a and the discharge opening 22a have the same width (the same length in the X-direction). However, the present disclosure is not limited to this. The inlet opening and the discharge opening may have different widths. That is, the width of the discharge opening may be wider than the width of the inlet opening, or the width of the discharge opening may be narrower than the width of the inlet opening.

Further, the above embodiment deals with an example in which the inner end portion of the base 121a of the coating device 1a is placed in the predetermined region Ri, and the inner end portion of the base 121b of the coating device 1b is placed in the predetermined region Ri. However, the present disclosure is not limited to this. The whole bases of all the coating devices may be placed in the predetermined-region outside regions.

Further, the above embodiment deals with an example in which the support 13 is placed at a position that does not overlap the inlet opening 21a and the discharge opening 22a in a plan view. However, the present disclosure is not limited to this. The support may be placed at a position that overlaps at least one of the inlet opening and the discharge opening in a plan view. That is, the support may be placed in the predetermined region.

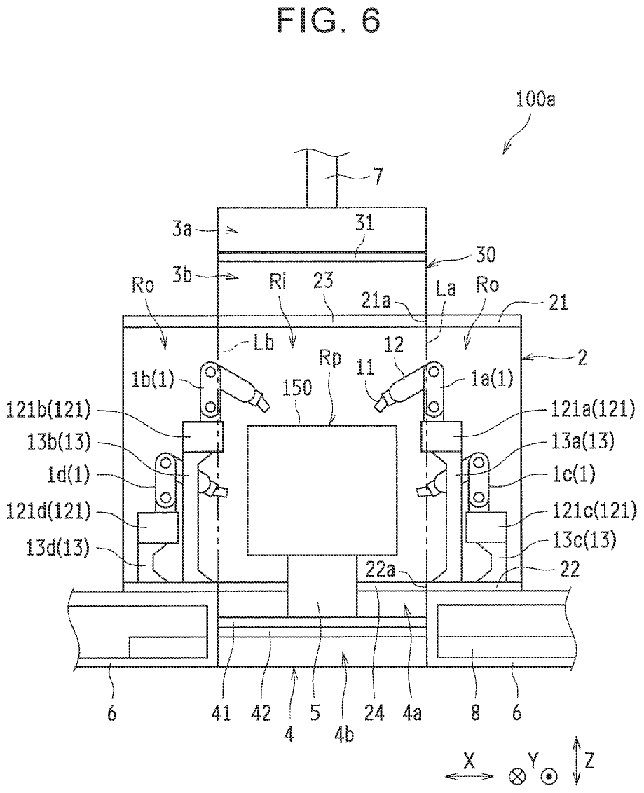

Further, the above embodiment deals with an example in which the coating chamber 2 and the supply air chamber 3 have the same width (the same length in the X-direction). However, the present disclosure is not limited to this. Like a coating booth 100a in a modification illustrated in FIG. 6, the width of the supply air chamber 30 may be made small in comparison with the width of the coating chamber 2. In this case, the width of the supply air chamber 30 may be the same as the width of the inlet opening 21a.

Further, the above embodiment deals with an example in which the air is released to outside from the recovery chamber 4 via the discharge air duct 8. However, the present disclosure is not limited to this. The air may be returned to the air conditioner from the recovery chamber via the discharge air duct.

Further, the above embodiment deals with an example in which the coating device 1 is not provided with an air-discharge portion configured to discharge shaping air. However, the present disclosure is not limited to this. The coating device may be provided with an air-discharge portion configured to discharge shaping air.

Further, in the above embodiment, the paint may be an aqueous paint or a solvent-based paint.

The present disclosure is applicable to a coating booth including a coating chamber in which coating is performed on a coated object by a coating device, a supply air chamber placed above the coating chamber, and a recovery chamber placed below the coating chamber, and to a coating method using the coating booth.

What is claimed is:

1. A coating booth comprising:
a coating chamber provided with a coating device configured to atomize paint and apply the paint to a coated object such that coating is performed on the coated object by the coating device;
a supply air chamber placed above the coating chamber, the supply air chamber being configured to supply air to the coating chamber; and
a recovery chamber placed below the coating chamber, the recovery chamber being configured to recover paint particles in air discharged from the coating chamber, wherein:
air directed from the supply air chamber toward the recovery chamber flows through a predetermined region inside the coating chamber, the predetermined region including a passage region for the coated object; and
the air directed from the supply air chamber toward the recovery chamber does not flow through a predetermined-region outside region inside the coating chamber.

2. The coating booth according to claim 1, wherein:
an inlet opening via which the air is introduced from the supply air chamber to the coating chamber is formed in a part of a ceiling of the coating chamber; and
the inlet opening is placed so as to correspond to the passage region for the coated object.

3. The coating booth according to claim 2, wherein:
the coating device includes a spray gun configured to atomize the paint, a robot arm configured to move the spray gun, and a support to which a base of the robot arm is attached; and
the support is placed at a position that does not overlap the inlet opening in a plan view.

4. The coating booth according to claim 1, wherein:
a discharge opening via which the air is discharged from the coating chamber to the recovery chamber is formed in a part of a floor of the coating chamber; and
the discharge opening is placed so as to correspond to the passage region for the coated object.

5. The coating booth according to claim 1, wherein:
the coating device includes a spray gun having a rotary head; and
the coating device is configured such that filamentous paint is emitted from the rotary head and the filamentous paint is electrostatically atomized.

6. A coating method using a coating booth including a coating chamber provided with a coating device configured to atomize paint and apply the paint to a coated object such that coating is performed on the coated object by the coating device,
a supply air chamber placed above the coating chamber, the supply air chamber being configured to supply air to the coating chamber, and
a recovery chamber placed below the coating chamber, the recovery chamber being configured to recover paint particles in air discharged from the coating chamber,
the coating method comprising:
a step of introducing air directed from the supply air chamber toward the recovery chamber into a predetermined region inside the coating chamber, the predetermined region including a passage region for the coated object, and preventing the air directed from the supply air chamber toward the recovery chamber from flowing through a predetermined-region outside region inside the coating chamber; and
a step of performing coating on the coated object by the coating device in a state where the air flows through the predetermined region while the air is prevented from flowing through the predetermined-region outside region.
